(19) United States
(12) Patent Application Publication
(10) Pub. No.: US 2021/0234891 A1
(43) Pub. Date: Jul. 29, 2021

(54) ARTIFICIAL INTELLIGENCE (AI) POWERED CONVERSATIONAL SYSTEM FOR IDENTIFYING MALICIOUS MESSAGES

(71) Applicant: IRONSCALES LTD., Tel Aviv (IL)

(72) Inventor: Eyal BENISHTI, Dunwoody, GA (US)

(21) Appl. No.: 17/087,705

(22) Filed: Nov. 3, 2020

Related U.S. Application Data
(60) Provisional application No. 62/966,602, filed on Jan. 28, 2020.

(51) Int. Cl. H04L 29/06; H04L 12/58; G06F 16/9035; G06F 16/906

(52) U.S. Cl. CPC H04L 63/1483; G06F 16/906; G06F 16/9035; H04L 51/02

(57) ABSTRACT

The subject matter discloses artificial intelligence (ai) powered conversational system for identifying malicious messages

### FIELD OF THE INVENTION

The present disclosure relates to the field of Internet security. More particularly, the invention relates to a method of detecting malicious messages.

### BACKGROUND OF THE INVENTION

Phishing is the attempt to obtain sensitive information such as usernames, passwords and credit card details, often for malicious reasons, by disguising as a trustworthy entity in an electronic communication

Phishing is typically carried out by email spoofing or instant messaging and it often directs users to enter personal information at a fake website, the look and feel of which are almost identical to the legitimate one communications purporting to be from social web sites, auction sites, banks, online payment processors or it administrators are often used to lure victims. Phishing emails may contain links to websites that are infected with malware.

Phishing may also be used for attacking organization. In some cases the phishing message has a network address or a domain that is similar to a network address or domain that is known to the user or to the organization.

### SUMMARY OF THE INVENTION

The term computing device refers herein to a device that includes a processing unit. Examples for such device are a personal computer, a laptop, a server, a tablet a cellular device and IOT (internet of things) device.

The term message is used to indicate an electronic form of exchanging digital content from an author to one or more recipients. This term does not imply any particular messaging method, and the invention is applicable to all suitable methods of exchanging digital messages such as email, SMS, Instant Messaging (IM), Social Media Websites and the like.

The term messaging service refers herein to a service for enabling the communication with messages. Examples for such services are SMS, Instant Messaging (IM) email messaging and the like.

The term classification refers herein to identification of a message or a sender of a message as malicious or suspicious or non-malicious or no-suspicious or identifying level of suspiciousness of a message or a sender of a message.

The term history of a sender refers herein to classification of messages that are sent from this sender, to the frequency of receiving messages in the organization by this sender, to the number of users in the organization that receive message from this sender, to duration of corresponding with the sender etc.

The term similar message refers herein to a message that essentially includes similar malicious contents, such as a link to a hazardous IP or a downloadable attachment containing a virus, or is luring the victim to response with data that might lead to an account being compromise for instance. The Similarity may be in the subject of the message or in the content of the body of the message.

Embodiments of the invention disclose system and method for assisting in identifying malicious messages. The system and method enable a user who suspects a message as suspicious or malicious to chat with a Chat Bot in order to classify the message. Embodiments of the invention provide automated AI powered conversational decision-making tool. The tool includes a Chat Bot for interfacing with the user. The tool may replace a human cyber analyst.

According to some embodiments the system may interact with the user in order to assist in the process of classifying a message or in order classify the message with the help of the user. The interacting includes exchanging data associated with the suspicious message and with the sender of the suspicious message and providing more context and visibility around the message or the sender of the message in regards to other messages from inside or from outside the organization associated with this message or the sender of the message. The interaction also includes presenting questions associated with the suspicious message, providing a selection of optional responses to the questions and suggesting the user to perform certain operations. The suggested operations may include, for example classifying the message, challenging the sender etc. The optional responses may include instructions for the system for performing operations such as classifying the message or authenticating the sender of the message or presenting content links that are embedded in the message and content of files that are attached to the message. The suggested responses may include instructions to the system for interrogating certain data associated with the suspicious message or the sender.

The interaction with the user is as a result of an analysis. The analysis is performed with respect to the suspicious message, metadata of the suspicious message, the sender of the suspicious message, history of sender, the data that is received from the user and data that was collected from other users history with the message/sender. The analysis may also be related to history of similar messages. The metadata may include, for example, headers like: Received, return-path, Sender, From, Subject, X-headers, domain name sender name.

The data that the system presents to the user provides visibility of the suspicious message and of the sender. Such data may include content of link that are embedded in the messages, content of attachments of the message, classification of the sender of the message, identification of other users that correspond with the sender, history of the sender, other people that were involved with the sender etc.

According to some embodiments the system may transform the links and attachments of the message to safe content or provide a safe preview prior to presenting the content to the user. The transforming may be by changing the file format or by extracting any potential risky elements from the file or any other mean that protects the user and it's environment from any potential damage.

The system may extract data from the suspicious message and presents to the user leading questions that are respective to the extracted data. For example, if the message includes a link or a file the system may present a leading question to the user in the form of “Show me a picture with the content of this file or this link”.

In another example the system may identify the sender's mailing address as associated with a popular brand. In such an example the system may present to the user a leading question such as “It appears a popular Brand, am I the only one receiving those emails?” In another example the system identifies that the sender is communicating with other users in the organization.

The system may post a leading question such as: this sender is corresponding with John Smith from the organization, do you know John Smith. The system may suggest the following responses: yes I now John and I am trusting the sender, No I do not know John can you show me name of other users in the organization that are communicating with John

One problem dealt with by the present invention is how to enable a user to identify suspicious or malicious messages. Some users of messaging service may not have the skills and/or abilities to identify malicious attacks. In some cases users are finding it hard to decide about the maliciousness of an email and, in particular, a message that is received from an unknown user. Sometimes users suspect a message but decide to ignore or delete the message instead of getting to the bottom of the message due to lack of technical skills or because they don't want to bother the security team.

One other problem is how to utilize the data and knowledge of a recipient in a computerized process of classifying a message.

One technical solution is providing a artificial intelligence (AI) powered conversational Chat Bot that can mimic the investigation process done by a human security expert and can provide more data point to the user before making a decision. Such a chat bot extracts some contextual based information from the user using a chat protocol that leads the user with questions.

The Chat Bot may utilize API (application interface) to tools such as the WATSON tool.

In some embodiments the chat is initiated by the system; for example when the system suspects that a certain message is malicious and may request information from the user. In some other embodiments the chat is initiated by the user of the system in order to classify the message.

The chat may be initiated by various online communication methods. Such methods include but not limited to emails or other messaging services, user interface for chats, newsletters, blog subscriptions questions etc.

In some embodiments the system performs analysis with the data that is received from the user and/or with data that is stored in the system and is associated with same message or similar messages. The analysis may be performed by methods such as neural networks, deep learning and machine learning.

In some embodiments the system presents the result of the analysis to the user and requests the user to classify the message based on the results. If the message is classified as suspicious the system may request the user to decide if he wishes to continue with the investigation or if he wishes to involve the security team.

Some aspects of the present disclosure relate to a non transitory computer readable medium comprising instructions which when executed by at least one processor causes the processor to perform the method of the present disclosure.

Embodiments of the invention may be implemented as a computer process (method), a computing system, or as an article of manufacture, such as a computer program product or a non-transitory computer-readable media. The computer program product may be a computer storage media readable by a computer system and encoding a computer program of instructions for executing a computer process on the computer and network devices. The computer program product may also be a propagated signal on a carrier readable by a computing system and encoding a computer program of instructions for executing a computer process.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 shows a block diagram of an interactive system for identifying malicious messages, in accordance with some exemplary embodiments of the subject matter;

FIG. 2 shows a flowchart diagram of an interactive method for identifying malicious messages, in accordance with some exemplary embodiments of the disclosed subject matter;

FIG. 3 shows a flowchart diagram of a first scenario of identifying malicious messages, in accordance with some exemplary embodiments of the disclosed subject matter; and

FIG. 4 shows a flowchart diagram of a second scenario of identifying malicious messages, in accordance with some exemplary embodiments of the disclosed subject matter.

### DETAILED DESCRIPTION

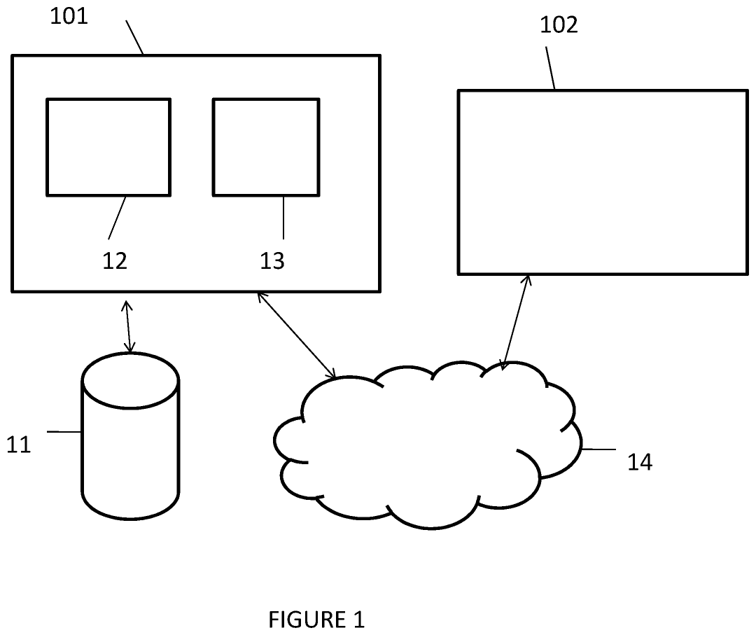

FIG. 1 shows a block diagram of a system for assisting in identifying malicious messages, in accordance with some exemplary embodiments of the subject matter.

System 100 includes a server computing device 101 and a user computing device 102.

The server computing device 101 may include a data repository 11, a chat bot module 12 and an analysis module 13. In some embodiments the data repository 11 is external to the server 101.

The chat bot module 12 is configured for performing chats between users and the system and for interacting with the user via chat. The interacting is for classifying the messages.

The analysis module 13 is configured for analyzing a message and for assisting in classifying the message. In some embodiments the classifying is performed by the user after receiving the results of the analysis. In some other embodiments the analysis module 13 classifies the message. The analyzing may be performed by neural network, deep learning or machine learning methods; for example the system can check how security analysts where handling previous cases with similar parameters or how or what questions a human analysts asked the user over the chat in order to learn how to investigate better. The system can learn using Machine Learning methods what questions belong to what emails and senders based on past labeled data. Such machine learning method may include NLP (Natural Language processing). The training the may be based on previous chats and data associated with messages collected by the system.

The analysis module communicates with the chat bot module 12 for receiving/transmitting instruction and data from/to the user. The data that may be received from the user may include, the message to be investigated, links that are attached to a message, meta data associated with the message etc. The data that is transmitted to the user may include classifications of this message or similar messages by other users. The communication may be via the internet cloud 14.

The analysis module 13 communicates also with the data repository 11 for extracting data associated with previous classification of messages. The previous classification may be performed by users, external resources or by previous processing of the analysis module 13. The communication may be via the internet cloud 14.

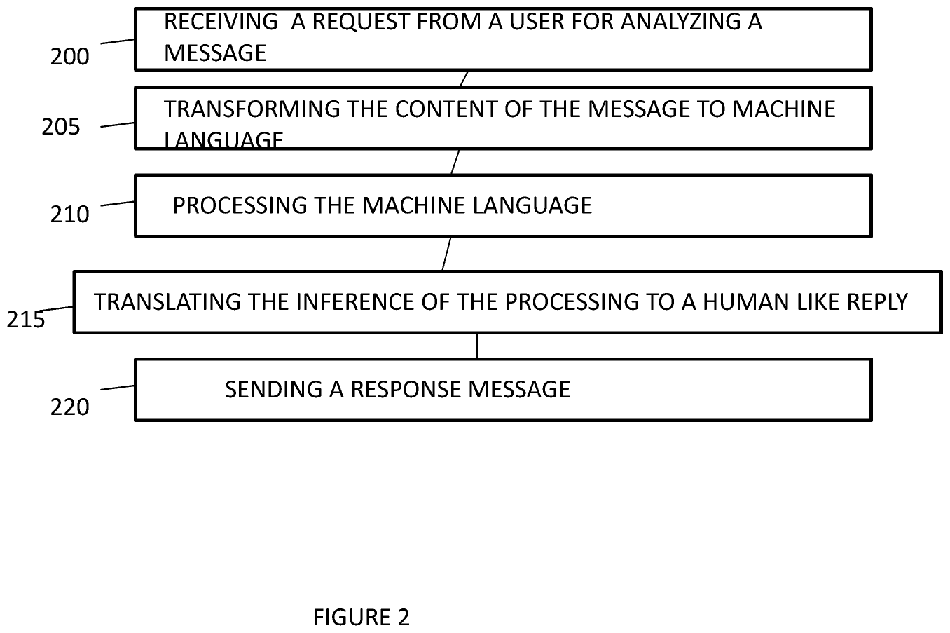

FIG. 2 shows a flowchart diagram of a method for assisting in identifying malicious messages, in accordance with some exemplary embodiments of the disclosed subject matter. 5

At block 200 the system receives a request from a user for assisting in classifying the message or for authenticating the sender of the message. The request may be received via email, a web page, via a social network media or via any other platform that communicates via the internet. The request may include a recording of a user or a natural language text. Such natural language may be English, French etc. In some other cases the system may initiate the chat without the intervention of the user for example upon identifying a suspicious email and a result of initiating a chat with the user to see if he wants more information or would like to report it a s suspicious or safe.

At block 205 the system performs semantic analysis and natural language processing for transforming the content of the message to machine language.

At block 210 the system analyses the message. The processing may include queering a data repository for previous classification of same or similar message or other message received from the same sender, analyzing the content of the message, analyzing meta data of the message, analyzing links that are attached to the message, querying external resources, etc. The analysis may include machine learning or deep learning methods. The system learns previous conversations in the context of similar emails and senders in order to find the right actions and questions to ask.

As a result of the processing, the system makes inference about the suspiciousness level of the message and/or about the authentication of the sender. The inference may be generated by the machine learning or the deep learning process.

As a result of the inference the system may classify the message or authenticate the sender.

As a result of the inference the system may query the user for additional information

As a result of the inference the system may suspend the process for a timeout due to lack of data and may resume processing after a timeout.

As a result of the inference the system may provide informative data to the user for assisting the user in classifying the message or authenticating the user. Such informative data may include suspiciousness level of similar or same message, information about the sender etc. Example of such informative data is “Ten users have report the mail as suspicious”

As a result of the inference the system may present questions and leading response options.

example of question is: what would you like to do now?

Example of leading responses

<Report as suspicious>

<suspend the process>

<show me content of the link of the mail>

The system may also enable the user to enter free text as response.

At block 215 the system translates the inference to a human like reply. The translation may be performed by, for example Natural Language Processing methods. Examples of such methods are Transfer Learning through pre-trained models.

At block 220 a response message that includes the human-like reply is sent to the user. The response may include a classification of the message, a suggestion for classifying the message in a certain classification, a request for additional data, a question with optional responses etc.

The operation may repeat until the message is classified by the user or by the system or until the sender is authenticated until the user requests to terminate the process.

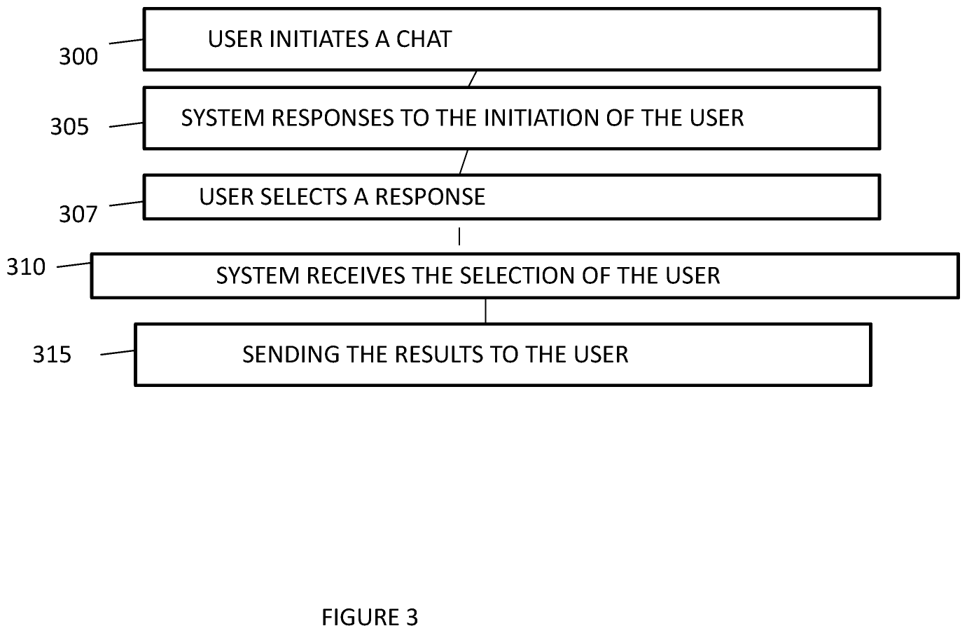

FIG. 3 shows a flowchart diagram of a first scenario of assisting in identifying malicious messages, in accordance with some exemplary embodiments of the disclosed subject matter.

In one example the user receives a suspicious email. The user initiates a chat bot session with the system for investigating the message.

At block 300 the user initiates a chat from its WEB in order to classify the message. The initiating may be by clicking on a <learn more> banner of a received message. In some cases the chat is initiated as a result of identifying a suspicious message by the system.

At block 305 the system responses to the initiation of the user. An example for such a response may be “Hi {name}, I see that you have some concerns regarding this email marked as potential threat, anything I can help with?”

The system may also provide predefined optional responses to the user. Examples for such responses are:

[ ] which indicates a pre-set button answer

[Nothing really, thanks!]

[I need more details about this sender, what can you tell me?]

[It appears a popular Brand, am I the only one receiving those emails?]

At block 307 the user selects a response.

At block 310 the system receives the selection of the user. The system performs an analysis in accordance with the request of the user. For example: if the request is “I need more details about this sender, what can you tell me?” the system may query for data associated with the sender and/or similar messages and returns the data to the user.

In another example if the user selects the query <It appears a popular Brand, am I the only one receiving those emails?>, the system may queries for other messages received from the sender by other recipients. If this is the first time that the sender is sending a message then the system may response <you are the first user to receive a mail from this sender> If the sender has already sent messages then the system may check the message type that was identified by other users and may send a response such as <this message was identified by five users as a suspicious message. One of the users is categorized with high level of awareness to detecting suspicious and malicious messages>.

At block 315 the system sends the results to the user.

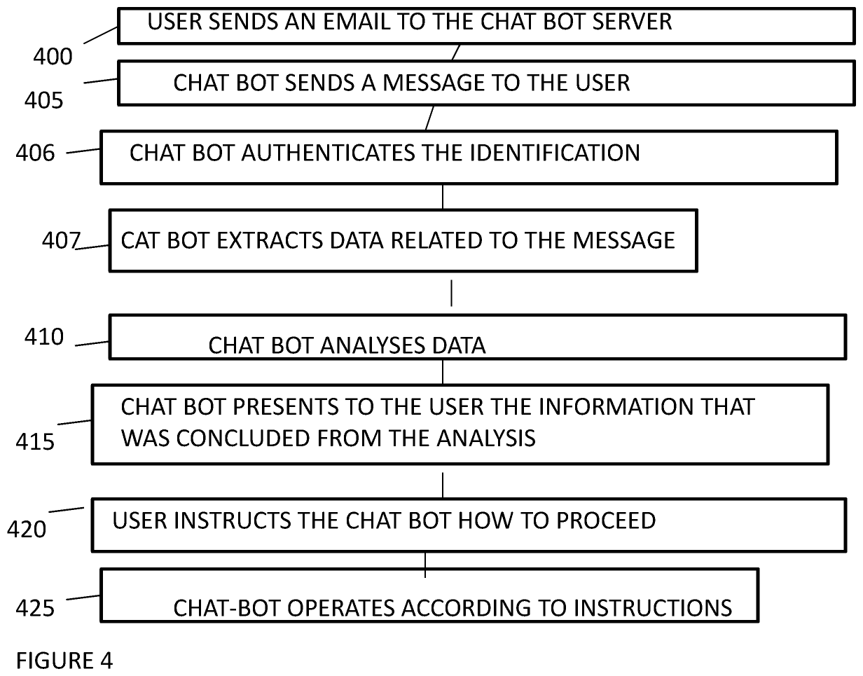

FIG. 4 shows a flowchart diagram of a second scenario of assisting in identifying malicious messages, in accordance with some exemplary embodiments of the disclosed subject matter. In one case the user receives an email he is not sure about. Instead of reporting the email as phishing he forwards the email to the Chat Bot server for starting a communication session with the Chat Bot.

At block 400 the user sends an email to the Chat Bot server for assisting in classifying a message.

At block 405 the Chat Bot sends a message to the user. The message is Hi <user name> I see you are not sure about the nature of this email, I am happy to help you investigate it further, here is some info I have right away that can help you make a decision. The Chatbot may then request an identification of the user. Such identification may include sender's fingerprint and human readable data.

At block 406 the Chat Bot authenticates the identification of the user.

At block 407 the Cat Bot extracts data related to the message from a data repository and sends the data to the user.

At block 410 the Chat Bot analyses data related to the message

At block 415 the Chat Bot presents to the user the information that was concluded from the analysis. Such information may include affected mailboxes by this sender, a list of other recipient of same or similar message that reported the message as suspicious or malicious, links associated with attachments of the message etc.

At block 420 the user instructs the Chat Bot how to proceed according to a list of options that are represented to the user. Such options may be

[Keep monitoring this email for the next hour or so let me know if something change]

[Report as Phishing]

[Show me the page behind this link]

[Show me a picture with the content of this file]

[Authenticate this sender on my behalf (sms/call/email to known source)]

[It seem like coming from a popular Brand, are you familiar with this sender?]

[Show me the page behind this link]

At block 425 the Chat-Bot operates according to instructions of the user.

Blocks 415, 420 and 425 may repeat until the message is classified or until the user or the chat-bot decides to terminate the session.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It should be noted that, in some alternative implementations, the functions noted in the block of a figure may occur out of the order noted in the figures. For example, two blocks shown in succession may, in fact, be executed substantially concurrently, or the blocks may sometimes be executed in the reverse order, depending upon the functionality involved.

What is claimed is:

1. A method the method comprises:
initiating to a user or receiving from said user a request for interactive classifying a message or for authenticating a sender of said message;
in response to said request performing analysis of said message;
interacting with said user for said classifying said message; said interacting corresponding with said analysis; and
classifying said message as a result of said interacting.

2. The method of claim 1 wherein said interacting is via a chat bot.
